(19) United States
(12) Patent Application Publication
(10) Pub. No.: US 2022/0014340 A1
(43) Pub. Date: Jan. 13, 2022

(54) BEARER CHANNEL ACCOMMODATION HINTING IN 5G TELECOM NETWORKS

(71) Applicant: International Business Machines Corporation, Armonk, NY (US)

(72) Inventors: Gandhi Sivakumar, Bentleigh (AU); Lynn Kwok, Bundoora (AU); Kushal S. Patel, Pune (IN); Sarvesh S. Patel, Pune (IN)

(21) Appl. No.: 16/925,792

(22) Filed: Jul. 10, 2020

(51) Int. Cl. H04L 5/00; H04W 76/32; H04W 76/11; H04W 48/16

(52) U.S. Cl. CPC H04L 5/0098; H04W 48/16; H04W 76/11; H04W 76/32

(57) ABSTRACT

In an approach to defining and symphonizing serverless functions of hybrid multi-cloud services, responsive to receiving a message to deallocate one or more bearer channels, a count of deletion requests is retrieved, where the count of deletion requests includes the one or more deallocated bearer channels. Responsive to determining the type of bearer channel deleted, an appropriate connected device is selected, where the appropriate connected device is chosen from the group consisting of a connected user equipment, a peer base station, and a gateway. A hinting message is sent to the appropriate connected device that the one or more deallocated bearer channels are available.

### BACKGROUND

The present invention relates generally to the field of wireless communication networks, and more particularly to bearer channel accommodation hinting in Fifth Generation (5G) telecommunications (telecom) networks.

5G, the 5th generation of mobile networks, is a significant evolution of 4G Long Term Evolution (LTE) networks. 5G has been designed to meet the very large growth in data and connectivity not only of User Equipment (UE) such as smart phones, but also the internet of things (IoT) with billions of connected devices, and new technologies such as driverless cars. 5G will initially operate in conjunction with existing 4G networks before evolving to fully standalone networks in subsequent releases and coverage expansions.

### SUMMARY

Embodiments of the present invention disclose a method, a computer program product, and a system for bearer channel accommodation hinting in 5G telecom networks. In one embodiment, responsive to receiving a message to deallocate bearer channels, a count of deletion requests is retrieved, where the count of deletion requests includes the deallocated bearer channels. Responsive to determining the type of bearer channel deleted, an appropriate connected device is selected, where the appropriate connected device is either a connected user equipment, a peer base station, or a gateway. A hinting message is sent to the appropriate connected device that the one or more deallocated bearer channels are available.

### BRIEF DESCRIPTION OF THE DRAWINGS

FIG. 1 is a functional block diagram illustrating a distributed data processing environment, in accordance with an embodiment of the present invention.

FIG. 2 is an example of the typical architecture of an Evolved Node B (eNodeB), in accordance with an embodiment of the present invention.

FIG. 3a is an example of a 5G LTE network, with three UE devices connected to the network, in accordance with an embodiment of the present invention.

FIG. 3b is the example 5G LTE network from FIG. 3a, where one of the three UE devices connected to the network has disconnected two of its four channels from the network, in accordance with an embodiment of the present invention.

FIG. 3c is the example 5G LTE network from FIG. 3a, illustrating the handshake between the UE and the eNodeB to add two additional channels to one of the UE devices, in accordance with an embodiment of the present invention.

FIG. 4 is a flowchart depicting operational steps of the section of code performed by the channel hinting program upon reception of a message to deallocate channels, within the distributed data processing environment of FIG. 1, in accordance with an embodiment of the present invention.

FIGS. 5a, 5b, 5c, and 5d are a flowchart depicting operational steps of the section of code performed by the channel hinting program upon reception of a notification request with deallocated bearer channels, within the distributed data processing environment of FIG. 1, in accordance with an embodiment of the present invention.

FIG. 6 depicts a block diagram of components of the computing device executing the channel hinting program within the distributed data processing environment of FIG. 1, in accordance with an embodiment of the present invention.

### DETAILED DESCRIPTION

5G is the fifth generation of mobile networks, a significant evolution of 4G LTE networks. 5G allows the mobile network to not only interconnect people, via smart phones, but also interconnect and control machines, objects, and devices. It delivers new levels of performance and efficiency to empower new user experiences and connect new industries. 5G can deliver multi-gigabits per second peak rates, ultra-low latency, massive capacity, and a more uniform user experience. 5G brings three new aspects to the table: bigger channels (to speed up data), lower latency (to be more responsive), and the ability to connect a lot more devices at once (for sensors and smart devices).

In a 5G telecom network, the Medium Access Control (MAC) Layer of the 5G New Radio (NR) provides services to the Radio Link Control (RLC) layer, and controls are provided in the form of logical channels. These logical channels are a virtualized communication network interface that is used to transfer IO commands (network data packets) and control instructions over the radio interface and 5G fixed access networks. A logical channel is defined by the type of information it carries and is generally differentiated as a control channel, used for transmission of control and configuration information, or as a traffic channel used for the user data. 5G NR technology allows for creating multiple logical channels over a single radio bearer network using 5G network slicing models. These channels are used to carry specialized traffic from a UE device to the 5G network. As multiple channels are created from a single device to the 5G network, the channels deliver parallelism in packet transmission, and reduce the exclusive locking of the 5G network resources to yield performance benefits.

These point-to-point channels, dedicated to one UE for the transfer of user information, are called Dedicated Traffic Channels (DTCHs). Since all the logical channels are created over the radio interface, an eNodeB is responsible for management of these DTCHs over the radio interface. The eNodeB is a complex base station that handles radio communications with multiple devices in the cell and carries out radio resource management and handover decisions. In the eNodeB, the resources are allocated to the DTCH based on its function. These functions can include the S1, which connects the eNodeB to the Evolved Packet Core (EPC) (the interface to the external network), the radio, etc., and the parameters of the DTCH are negotiated at the time the channel is created. The eNodeB manages the logical channel over the NR and connects with the Serving Gateway (S-GW). The main function of the S-GW is the routing and forwarding of user data packets. It is also responsible for inter-eNodeB handovers in the user plane and provides mobility between LTE and other types of networks. The eNodeB transmits the packets collected from all the channels using compression, alignment and multiplexing techniques. The data sent and received in a bearer channel is transported by an S1 bearer between an S-GW and an eNodeB, and by a radio bearer between a UE and an eNodeB.

A 5G telecom network can support many queues that can be created between a UE device and an eNodeB. But, the eNodeB has a limited set of hardware resources, and these resources must be shared across the logical channel processing for all the UE devices connected to the eNodeB. This limited set of resources needs to be used efficiently to handle multiple users, each user having multiple DTCHs, to get optimal performance. Each bearer channel at the eNodeB is allocated a resource set that comprises memory, storage, and networking elements. The bearer channel needs contiguous memory regions to write the packets coming over the radio interface. The amount of memory required increases as the number channels increases, which limits the number of channels that can be created over an eNodeB. In addition, in a complete 5G subsystem, each eNodeB is connected to other eNodeBs in the cell via internal S1 bearers and to the S-GWs, which also take memory resources. As these resources are allocated, other resources may become available. But the devices, such as the UE devices, may not be aware that these additional resources have become available, and therefore these devices continue to operate at less than optimal capacity. The following is an example of one such scenario.

In this example, an eNodeB contains 1000 megabytes (MBs) of memory available for allocation to the DTCH creation and management space, and each DTCH requires 10 MB of memory. The eNodeB, therefore, supports 100 bearers in total. There are typically multiple types of bearers that need to be created (e.g., eNodeB-to-eNodeB, eNodeB-to-UE, eNodeB-to-S-GW) that combine to form the 100 bearers that the example eNodeB can support. In this example, as the resource limits of the eNodeB are exhausted, the eNodeB has created fewer channels between the UE and the eNodeB than the UE could support. These UEs, therefore, are operating at less than full capacity. In the present art, the number of DTCHs are negotiated at the time of UE and eNodeB handshaking over the Common Control Channel (CCCH), and the number of DTCHs remains constant as long as the connection remains operational. However, if some of the logical bearers are detached, then the eNodeB resources allocated to those logical bearers are deallocated, and are available for reallocation. For example, if three DTCHs are disconnected by UE1 because the associated application no longer requires these bearers, then the eNodeB resources are deallocated. But in the present art, even if the eNodeB has free resources that can be allocated to create additional bearers, these other entities are unaware of this availability. In this example, there are channels available that go unallocated, and parallelism benefits are underutilized.

The present invention is a mechanism to monitor the availability of resources for all devices connected to the eNodeB in a 5G cellular network. When resources are deallocated and a connected device has capacity for additional channels, either in-band MAC-based protocol event signaling or out-of-band API-based information exchange messaging is utilized to trigger the creation of additional bearer channels for that device. This improves resource utilization and increases performance.

The present invention provides a method, computer program product, and system to trigger an event to connected UE devices and internal system components for hinting of the additional bearer handling capability of the eNodeB. The present invention will work with virtual network functions and the service programmability framework of 5G telecom networks. This hinting message will be delivered to connected UE devices and internal system components to indicate the additional resource availability at the eNodeB which can then be leveraged to allocate additional DTCHs to those devices. The present invention provides a mechanism for increased utilization of resources allocated for DTCH creation and management for the eNodeB system. When the bearer allocation resources of the eNodeB are completely occupied by all bearer channels, the present invention is activated to optimally track the available resources and notify the connected devices when any of these resources become available by the existing bearer deallocation process.

Similar to the example above for the current art, the following is an example of a similar system, but in this example the present invention will reallocate channels that are no longer in use by other devices, thereby increasing system performance.

In this example, a 5G eNodeB system can accommodate maximum 100 bearers and all 100 bearers have been created and attached to either external or peripheral entities (e.g., UE devices or s1 interfaces). In this example, if one or more entities disconnect any of the bearers (radio or s1), then the present invention checks the existing connections for all the resources that could potentially utilize these available bearers, and triggers a message to the system advising of the newly available resources for additional bearers. In some cases the eNodeBs have limits enabled on the maximum bearers per UE. In these cases, the message will be sent to only those UEs that do not have limits enabled on the maximum bearers per UE. For example, if the maximum bearers per UE is limited to 10 and UE1 has 5 DTCHs, then the present invention will send the message to UE1 since it is currently below the limit. This will help optimize the broadcasting of availability messages by ensuring that only eligible candidates will receive the messages.

The invention can utilize either in-band CCCH messages or an out-of-band API can be used with a proprietary protocol.

The present invention further complies with dedicated bearer reservation limits for UEs, other eNodeBs, and S-GWs and accordingly selects whether to allow creation of temporary bearers or permanent bearers based on the policy. In the example, if S-GW bearers are detached, and the eNodeB controller has a policy which reserves 10 logical bearers for the S-GWs, then all other S-GWs are messaged. If none of the S-GWs create additional bearers, then the UEs are notified that additional temporary DTCH space is available to create additional UE bearers. These temporary channels will be detached in case a request comes from the S-GWs to allocate additional channels from the 10 reserved channels.

When the UE or other initiator entity receives the availability message, it polls the existing logical bearers between itself and the eNodeB to determine whether to accept the additional bearers. The initiator will determine whether to accept the additional bearers based on the packet data workload pattern of the initiator. For example, if a UE workload is using small packets, then it will gain performance by creating additional bearers. On the other hand, if a UE workload is using larger packets (which might not benefit from additional parallel channels) or has a lower performance requirement, then the UE may elect not to accept the allocation of the additional bearers.

If the initiator elects to create the additional logical bearers, then a message is received over the CCCH and the channels will be established. Once the connection is established, the initiator collects information about the bearers (i.e., temporary/additional/spare/permanent) and updates the local metadata map of a bearers table. This can be used in case of future disconnect request operations and other advanced bearer management operations. This bearer table metadata allows the initiator devices to be aware of the status of the bearers, thereby avoiding the situation where all permanent channels are disconnected and the temporary are detached by the eNodeB. This will ensure the overall connectivity.

In addition, when the additional bearers are created, the eNodeB maps the status of the bearers that are permanent or temporary based on the 5G telecom policies defined. In the case where the nature is temporary, the map of temporary bearers is updated. In case the create request comes from an entity that has a reserved pool of bearers, then some of the bearers will be detached and a new connect request is acknowledged with a success message. This will make the system compliant with the reservation policies and will provide parallelism benefits to the applications as well optimize resource utilization.

In some cases, if the UE device, even though it is not currently using the maximum number of bearers, has sufficient bandwidth for the running applications, then that UE can continue with the current bearers. In this case, it can simply ignore the availability message from the eNodeB, thereby allowing the available resources to be allocated to another entity.

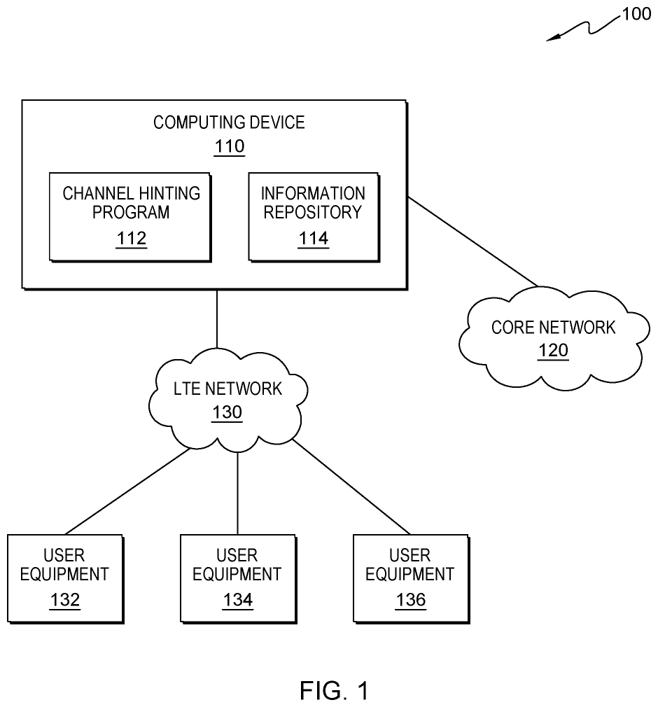

FIG. 1 is a functional block diagram illustrating a distributed data processing environment, generally designated 100, suitable for operation of channel hinting program 112 in accordance with at least one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110, and UE 132, 134, and 136, all connected to LTE network 130. Computing device 110 is also connected to core network 120. Core network 120 can be, for example, a telecommunications network, a local area network (LAN), a wide area network (WAN), such as the Internet, or a combination of the three, and can include wired, wireless, or fiber optic connections. Core network 120 can include one or more wired and/or wireless networks that are capable of receiving and transmitting data, voice, and/or video signals, including multimedia signals that include voice, data, and video information. In general, core network 120 can be any combination of connections and protocols that will support communications between computing device 110 and other computing devices (not shown) within distributed data processing environment 100.

Computing device 110 can be a standalone computing device, a management server, a web server, a mobile computing device, or any other electronic device or computing system capable of receiving, sending, and processing data. In an embodiment, computing device 110 can be a base station for a cellular communication network, including an eNodeB base station for a 5G telecommunications network. In an embodiment, computing device 110 can be a laptop computer, a tablet computer, a netbook computer, a personal computer (PC), a desktop computer, a personal digital assistant (PDA), a smart phone, or any programmable electronic device capable of communicating with other computing devices (not shown) within distributed data processing environment 100 via core network 120. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within distributed data processing environment 100.

In an embodiment, computing device 110 includes channel hinting program 112. In an embodiment, channel hinting program 112 is a program, application, or subprogram of a larger program for bearer channel accommodation hinting in 5G telecom networks. In an alternative embodiment, channel hinting program 112 may be located on any other device accessible by computing device 110 via core network 120.

In an embodiment, computing device 110 includes information repository 114. In an embodiment, information repository 114 may be managed by channel hinting program 112. In an alternate embodiment, information repository 114 may be managed by the operating system of the device, alone, or together with, channel hinting program 112. Information repository 114 is a data repository that can store, gather, compare, and/or combine information. In some embodiments, information repository 114 is located externally to computing device 110 and accessed through a communication network, such as core network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, cellular configuration data, cellular packet data, network packet data, control channel data, user data, system configuration data, and other data that is received by channel hinting program 112 from one or more sources, and data that is created by channel hinting program 112.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, the information repository 114 may be implemented with any suitable storage architecture known in the art, such as a relational database, an object-oriented database, or one or more tables.

LTE network 130 is a 5G wireless telecom network that connects UE 132-136 to computing device 110.

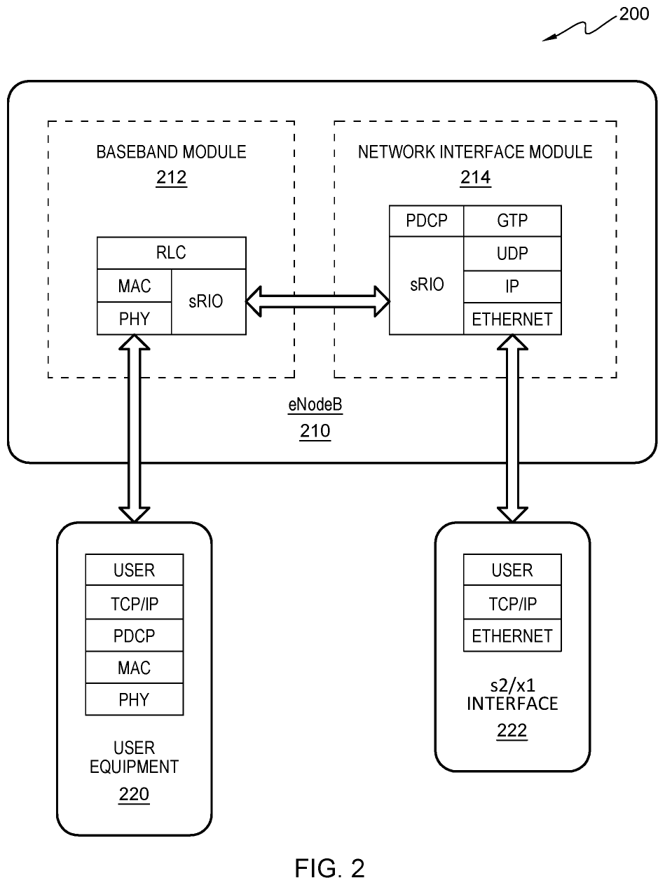

FIG. 2 is an example of the architecture of a typical cell in a 5G telecom network, generally designated 200, in accordance with at least one embodiment of the present invention. Cell 200 includes user equipment 220. User equipment 220 is a device, such as UE 132-136 of FIG. 1, that connects to cell 200 to allow the user to communicate over the 5G telecom network. UE 220 may be, for example, a smart phone, tablet, or IoT device. UE 220 connects to eNodeB 210, which represents a typical base station in the 5G telecom network. In various embodiments, the base station may be referred to as eNodeB, eNB, gNodeB, gNB, or any other term as would be known to a person in the art. ENodeB 210 contains baseband module 212, which is the cellular radio section of eNodeB 210. UE 220 connects to eNodeB 210 via the Radio Link Control (RLC) layer of baseband module 212.

ENodeB 210 also contains network interface module 214. Network interface module 214 connects eNodeB 210 to external devices via the Internet Protocol (IP) network. S2/x1 interface 222 connects to network interface module 214 of eNodeB 210. S2/x1 interface 222 connects eNodeB 210 to the S-GW which, as stated above, performs the routing and forwarding of user data packets throughout the telecom network.

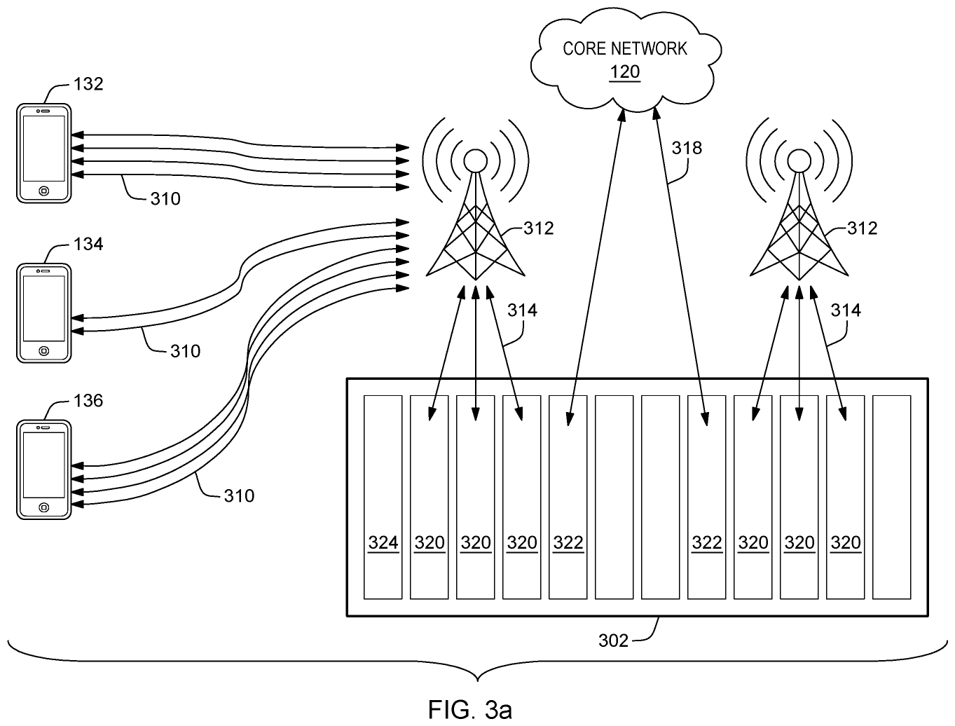

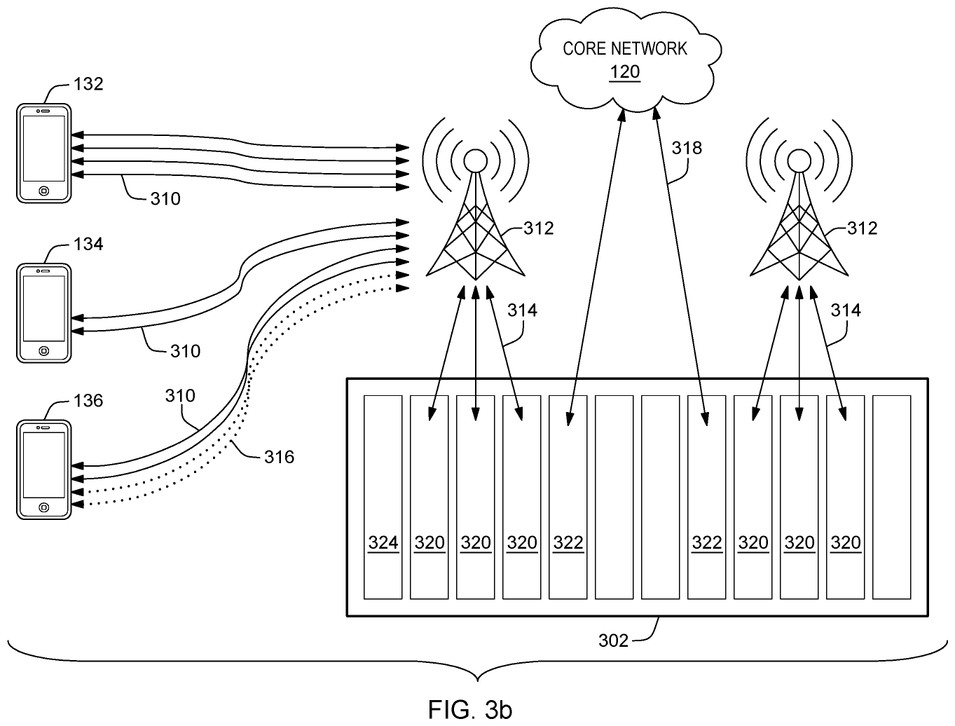

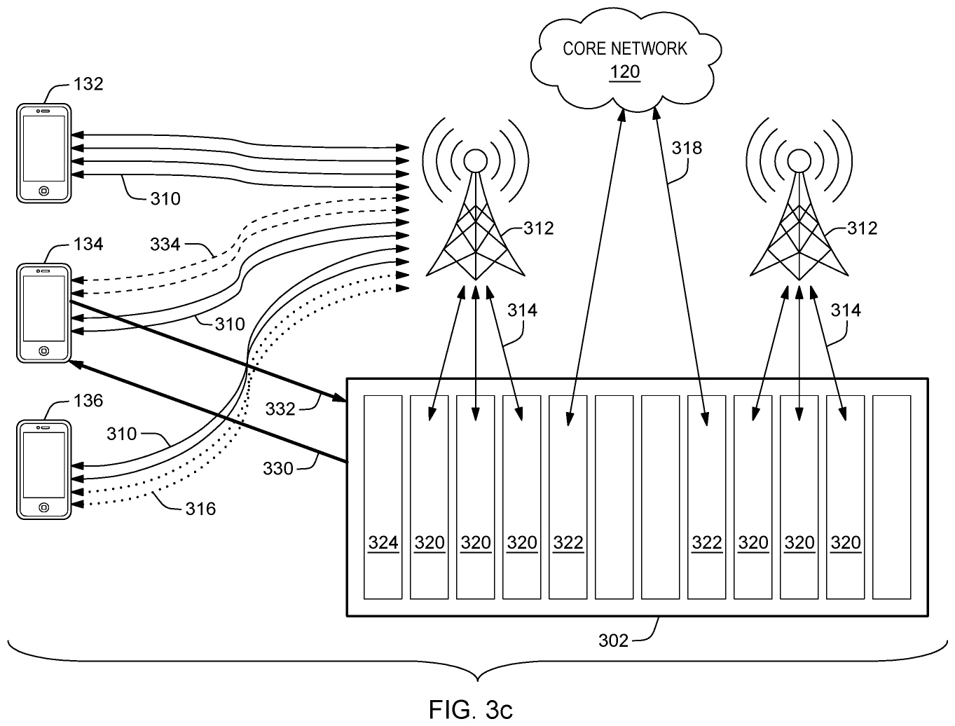

FIGS. 3a-3c illustrate an example of the operation of the present invention. FIGS. 3a-3c include UE devices 132-136. These are the UE devices, for example smart phones, from FIG. 1 that are connected to the 5G network. Channels 310 are the various channels between UE 132, UE 134, UE 136, and LTE baseband cards 320 of eNodeB 302. Towers 312 are examples of cellular network towers connecting the user equipment to eNodeB 302. Interfaces 314 are the connections between cellular network towers 312 and control and network cards 322 of eNodeB 302. The interface is typically either the Common Public Radio Interface (CPRI) or the Open Base Station Architecture Initiative (OBSAI). Core network 120 is the core cellular network that connects eNodeB 302 to other resources, such as the Internet. Network connections 318 are the various connections between eNodeB 302 and the core network 120. These connections are typically gigabit Ethernet or similar network connections.

In an embodiment, eNodeB 302 also includes notification manager 324, which provides the interface between eNodeB 302 and the UE devices UE 132, UE 134, UE 136, to provide the device notifications for additional scope availability at eNodeB 302. For example, if there is available space that can be consumed by the UE devices to create additional channels, then notification manager 324 selects a UE set, collects the IMEI numbers and other radio locators of the UE set and sends the notification frames to the target UE devices over NR bearers.

In FIG. 3a of this example, UE 132 and UE 136 have each created four DTCHs and eNodeB 302 supports a maximum of 10 DTCHs. Therefore, only two DTCHs are available for UE 134 even though it has the capacity to create four channels.

In FIG. 3b of this example, two channels are deallocated by UE 136, and therefore eNodeB 302 has free channels available to allocate to UE 134 to create additional logical channels. In this example, as is typical for the current art, UE 134 does not know that additional channels are now available on eNodeB 302. Item 316 shows that two of the four connections from UE 136 to eNodeB 302 have been released by UE 136.

FIG. 3c of this example illustrates the same situation of FIG. 3b, but in this example the present invention will allocate additional channels to improve throughput. Here, channel hinting program 112 performs a handshake between eNodeB 302 and UE 134 to allocate the additional logical channels to UE 134. Message 330 is an Event Request Message eNodeB sends to UE 134. Message 332 is an Event Response Message that UE 134 sends to eNodeB 302. Finally, message 334 is the exchange between eNodeB 302 and UE 134 to establish the connection of the two additional channels.

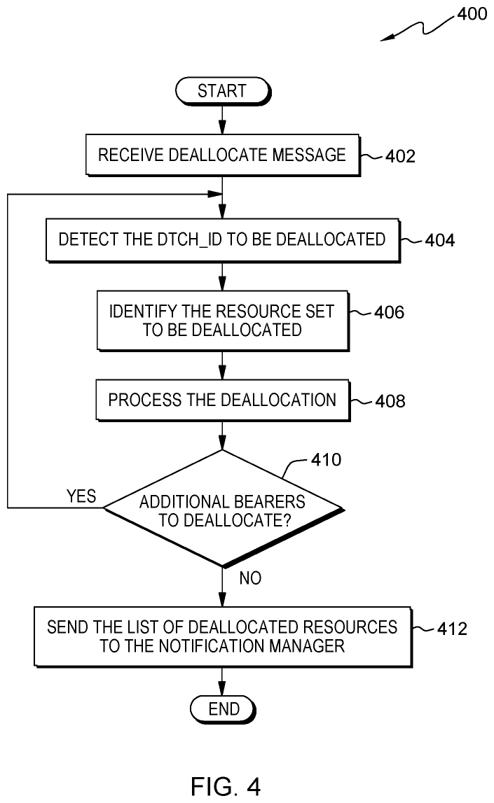

FIG. 4 is a flow chart diagram of workflow 400 depicting operational steps of the section of code performed by channel hinting program 112 upon reception of message to deallocate channels. In an alternative embodiment, the steps of workflow 400 may be performed by any other program while working with channel hinting program 112. In an embodiment, channel hinting program 112 receives a deallocate message. In an embodiment, channel hinting program 112 detects the DTCH_ID to be deallocated. In an embodiment, channel hinting program 112 identifies the resource set to be deallocated. In an embodiment, channel hinting program 112 processes the deallocation. In an embodiment, channel hinting program 112 determines if there are additional bearers to deallocate. In an embodiment, if channel hinting program 112 determines that there are no additional bearers to deallocate, then channel hinting program 112 sends the list of deallocated resources to a notification manager, for example, notification manager 324 from FIGS. 3a-3c.

It should be appreciated that embodiments of the present invention provide at least for the section of code performed by channel hinting program 112 upon reception of message to deallocate channels. However, FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

It should be appreciated that the process depicted in FIG. 4 is illustrates one possible iteration of the section of code performed by channel hinting program 112 upon reception of message to deallocate channels, which repeats each time a message to deallocate channels is received by channel hinting program 112.

Channel hinting program 112 receives a deallocate message (step 402). In an embodiment, channel hinting program 112 receives a message to deallocate channels. The message can be a BEARER_DEALLOCATE message over CCCH; a BEARER_DISLOCATE message on the Paging Control Channel (PCCH); or a BEARER_REMOVE event over DTCH.

Channel hinting program 112 detects the DTCH_ID to be deallocated (step 404). In an embodiment, channel hinting program 112 detects the DTCH_ID or BEARER_ID over the radio link connection of the resources to be deallocated.

Channel hinting program 112 identifies the resource set to be deallocated (step 406). In an embodiment, channel hinting program 112 identifies the resource set of the DTCH_ID or BEARER_ID that is to be deallocated and determines the resources that will be deallocated and therefore available for reallocation. These resources may include, but are not limited to, memory, storage, and networking elements.

Channel hinting program 112 processes the deallocation (step 408). In an embodiment, channel hinting program 112 processes the deallocation of the resources for the DTCH_ID or BEARER_ID.

Channel hinting program 112 determines if there are additional bearers to deallocate (decision block 410). In an embodiment, if channel hinting program 112 determines that the DTCH_ID or BEARER_ID is a set of BEARERs, then channel hinting program 112 determines if there are additional DTCH_IDs or BEARER_IDs that need to be deallocated. If channel hinting program 112 determines that there are additional DTCH_IDs or BEARER_IDs that need to be deallocated (“yes” branch, decision block 410), then channel hinting program 112 returns to step 404 to process the next DTCH_ID or BEARER_ID. If channel hinting program 112 determines that there are no additional DTCH_IDs or BEARER_IDs that need to be deallocated (“no” branch, decision block 410), then channel hinting program 112 proceeds to step 412.

Channel hinting program 112 sends the list of deallocated resources to the notification manager (step 412). In an embodiment, channel hinting program 112 sends the list to the notification manager of deallocated resources that are therefore available to be reallocated.

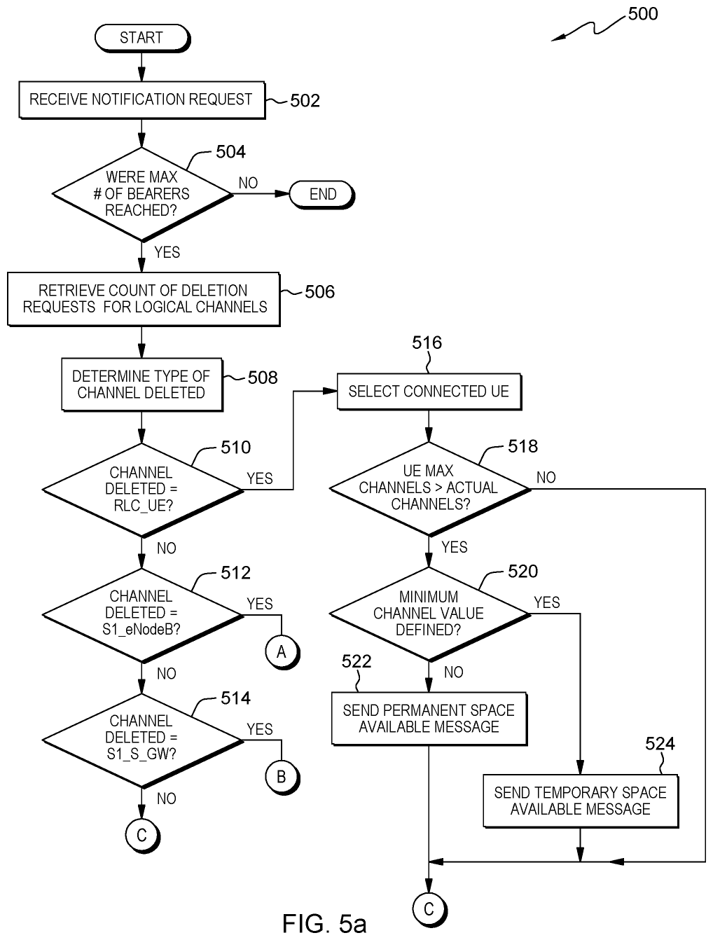

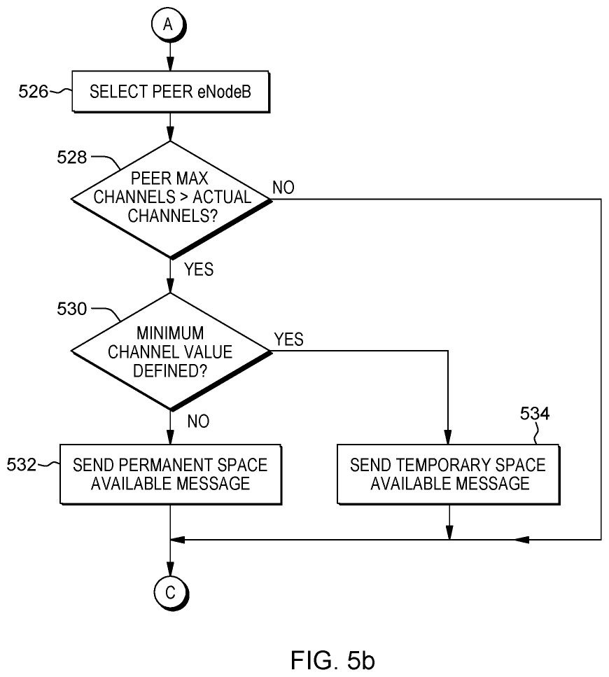

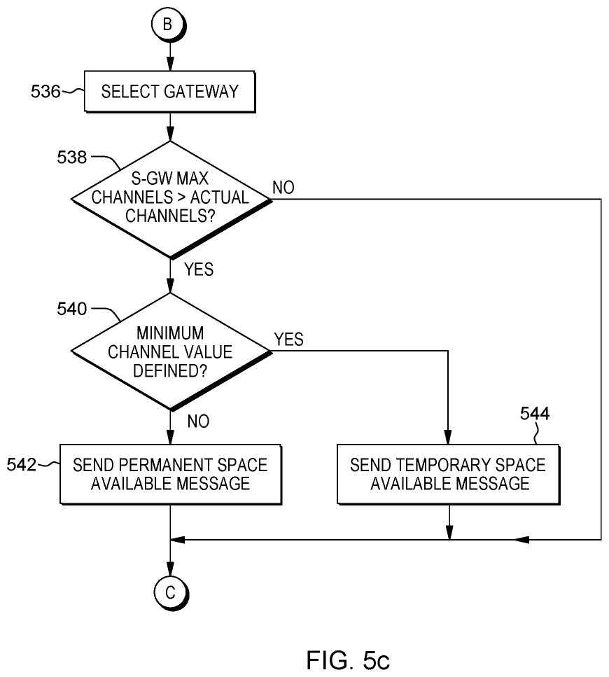

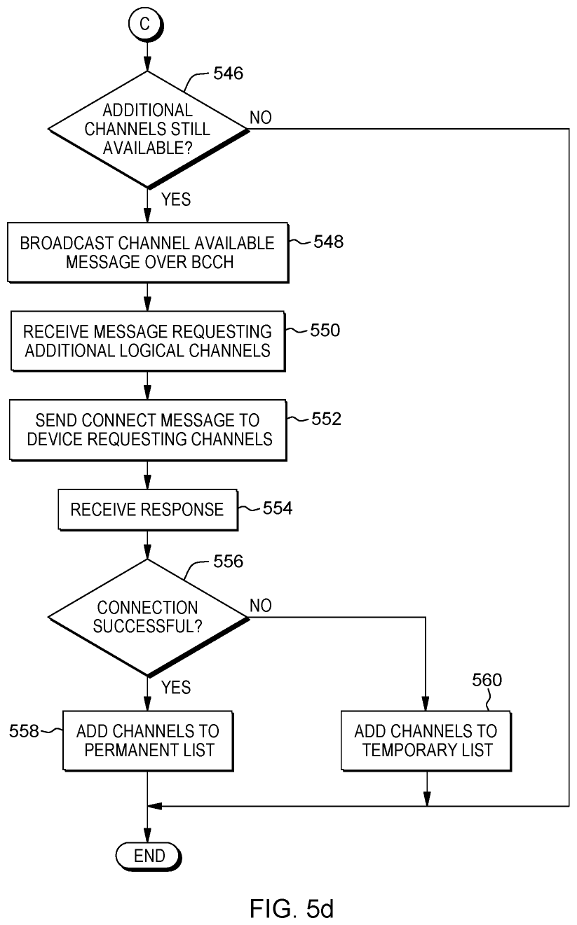

FIG. 5 is a flow chart diagram of workflow 500 depicting operational steps of the section of code performed by channel hinting program 112 upon reception of notification request with deallocated bearer channels. In an alternative embodiment, the steps of workflow 500 may be performed by any other program while working with channel hinting program 112. In an embodiment, channel hinting program 112 receives a notification request. In an embodiment, channel hinting program 112 determines if the maximum number of bearers were reached. In an embodiment, channel hinting program 112 retrieves the count of deletion requests for logical channels. In an embodiment, channel hinting program 112 determines whether the type of channel deleted are radio link control (RLC) channels between the UE device and the eNodeB; S1-MME interface channels between the eNodeB and the mobility management entity (MME); or S1_S_GW channels between the eNodeB and one of the serving gateways. In an embodiment, channel hinting program 112 determines if the deleted channel is an S1 ENODEB. In an embodiment, channel hinting program 112 determines if the deleted channel is an S1_S_GW. In an embodiment, if channel hinting program 112 determines that the notification request is to deallocate RLC_UE channels, then channel hinting program 112 selects a channel from which it has received a notification request with deallocated bearer channels. In an embodiment, channel hinting program 112 determines if the maximum number of channels supported by the UE device is greater than the number of channels currently allocated to the UE device. In an embodiment, channel hinting program 112 determines if a minimum number of channels per UE is defined for the system. In an embodiment, if channel hinting program 112 determines that the minimum number of channels per UE is not defined for the system, then channel hinting program 112 sends a BCCH message with permanent space available. In an embodiment, if channel hinting program 112 determines that the minimum number of channels per UE is defined for the system, then channel hinting program 112 sends a BCCH message with temporary space available. In an embodiment, if channel hinting program 112 determines that the notification request is to deallocate Peer eNodeB channels, then channel hinting program 112 selects a channel from which it has received a notification request with deallocated bearer channels. In an embodiment, channel hinting program 112 determines if the maximum number of channels supported by the Peer eNodeB selected is greater than the number of channels currently allocated to the Peer eNodeB. In an embodiment, channel hinting program 112 determines if a minimum number of channels per Peer eNodeB is defined for the system. In an embodiment, if channel hinting program 112 determines that the minimum number of channels per Peer eNodeB is not defined for the system, then channel hinting program 112 sends a BCCH message with permanent space available. In an embodiment, if channel hinting program 112 determines that the minimum number of channels per Peer eNodeB is defined for the system, then channel hinting program 112 sends a BCCH message with temporary space available. In an embodiment, if channel hinting program 112 determines that the notification request is to deallocate gateway channels, then channel hinting program 112 selects a channel from which it has received a notification request with deallocated bearer channels. In an embodiment, channel hinting program 112 determines if the maximum number of channels supported by the gateway selected is greater than the number of channels currently allocated to the gateway. In an embodiment, channel hinting program 112 determines if a minimum number of channels per gateway is defined for the system. In an embodiment, if channel hinting program 112 determines that the minimum number of channels per gateway is not defined for the system, then channel hinting program 112 sends a BCCH message with permanent space available. In an embodiment, if channel hinting program 112 determines that the minimum number of channels per gateway is defined for the system, then channel hinting program 112 sends a BCCH message with temporary space available. In an embodiment, channel hinting program 112 determines if additional channels are still available to be reallocated. In an embodiment, if channel hinting program 112 determines that no additional channels are available to be reallocated, then channel hinting program 112 ends for this cycle. In an embodiment, channel hinting program 112 broadcasts an appropriate message, based on the type of channels that are available, over the control channel to announce that additional channels are available to be allocated. In an embodiment, channel hinting program 112 receives a message from a device, e.g., a UE device, requesting that one or more of the recently deallocated channels be assigned to the device. In an embodiment, channel hinting program 112 sends a connect message to that device via a control instruction transfer of the Media Access Controller (MAC) protocol over the radio interface. In an embodiment, channel hinting program 112 receives a response from the device that requested additional channels. In an embodiment, channel hinting program 112 determines if the response from the device that requested additional channels indicates that the connection was successful. In an embodiment, if channel hinting program 112 determines that the connection was successful, then channel hinting program 112 adds the identification of the channels added to the device to the list of permanent channels. In an embodiment, if channel hinting program 112 determines that the connection was not successful, then channel hinting program 112 adds the identification of the channels added to the device to the list of temporary channels.

It should be appreciated that embodiments of the present invention provide at least for the operational steps of the section of code performed by channel hinting program 112 upon reception of notification request with deallocated bearer channels. However, FIG. 5 provides only an illustration of one implementation and does not imply any limitations with regard to the environments in which different embodiments may be implemented. Many modifications to the depicted environment may be made by those skilled in the art without departing from the scope of the invention as recited by the claims.

It should be appreciated that the process depicted in FIG. 5 is illustrates one possible iteration of the operational steps of the section of code performed by channel hinting program 112 upon reception of notification request with deallocated bearer channels, which repeats each time a notification request with deallocated bearer channels is received by channel hinting program 112.

Channel hinting program 112 receives a notification request (step 502). In an embodiment, channel hinting program 112 receives a notification request with deallocated bearer channels.

Channel hinting program 112 determines if the maximum number of bearers were reached (decision block 504). In an embodiment, channel hinting program 112 determines if the maximum number of channels available in the eNodeB was reached prior to the deallocation of step 502. In an embodiment, if channel hinting program 112 determines that the maximum number of channels available in the eNodeB was not reached prior to the deallocation of step 502 (“no” branch, decision block 504), then channel hinting program 112 ends for this cycle. Since the maximum number of channels available in the eNodeB was not reached prior to the deallocation, then all currently attached devices must have been allocated the maximum number of channels that each device can support, and therefore the normal channel allocation process will reallocate these channels.

In an embodiment, if channel hinting program 112 determines that the maximum number of channels available in the eNodeB was reached prior to the deallocation of step 502 (“yes” branch, decision block 504), then channel hinting program 112 proceeds to step 506.

Channel hinting program 112 retrieves the count of deletion requests for logical channels (step 506). In an embodiment, channel hinting program 112 retrieves the count of the channels to be deallocated from step 502.

Channel hinting program determines the type of channels deleted (step 508). In an embodiment, channel hinting program 112 determines whether the type of channel deleted are radio link control (RLC) channels between the UE device and the eNodeB; S1-MME interface channels between the eNodeB and the mobility management entity (MME); or S1 S_GW channels between the eNodeB and one of the serving gateways.

Channel hinting program 112 determines if the channel deleted=RLC_UE (decision block 510). In an embodiment, if channel hinting program 112 determines that the notification request is to deallocate RLC_UE channels (“yes” branch, decision block 510), then channel hinting program 112 proceeds to step 516. In an embodiment, if channel hinting program 112 determines that the notification request is not to deallocate RLC_UE channels (“no” branch, decision block 510), then channel hinting program 112 proceeds to decision block 512.

Channel hinting program 112 determines if the channel deleted=S1_ENODEB (decision block 512). In an embodiment, if channel hinting program 112 determines that the notification request is to deallocate S1_ENODEB channels (“yes” branch, decision block 512), then channel hinting program 112 proceeds to step 526. In an embodiment, if channel hinting program 112 determines that the notification request is not to deallocate S1_ENODEB channels (“no” branch, decision block 512), then channel hinting program 112 proceeds to decision block 514.

Channel hinting program 112 determines if the channel deleted=S1 S_GW (decision block 514). In an embodiment, if channel hinting program 112 determines that the notification request is to deallocate S1 S_GW channels (“yes” branch, decision block 514), then channel hinting program 112 proceeds to step 536. In an embodiment, if channel hinting program 112 determines that the notification request is not to deallocate S1 S_GW channels (“no” branch, decision block 514), then channel hinting program 112 proceeds to decision block 546.

Channel hinting program 112 selects a connected UE (step 516). In an embodiment, if channel hinting program 112 determines that the notification request is to deallocate RLC_UE channels (“yes” branch, decision block 510), then channel hinting program 112 selects a connected UE from which it has received a notification request with deallocated bearer channels.

Channel hinting program 112 determines if the UE max channels is greater than the actual channels (decision block 518). In an embodiment, channel hinting program 112 determines if the maximum number of channels supported by the UE device selected in step 516 is greater than the number of channels currently allocated to the UE device. If channel hinting program 112 determines that the maximum number of channels supported by the UE device selected in step 516 is not greater than the number of channels currently allocated to the UE device (“no” branch, decision block 518), then channel hinting program 112 proceeds to decision block 546. If channel hinting program 112 determines that the maximum number of channels supported by the UE device selected in step 516 is greater than the number of channels currently allocated to the UE device (“yes” branch, decision block 518), then channel hinting program 112 proceeds to decision block 520.

Channel hinting program 112 determines if the minimum channel value is defined (decision block 520). In an embodiment, channel hinting program 112 determines if a minimum number of channels per UE is defined for the system. If a UE device is configured such that it can create permanent channels with eNodeB, and space is available for more channels between the UE and the eNodeB, then channel hinting program 112 allocates temporary channels with this device. This allows the temporary channels to be disconnected since the UE will always have connectivity via the permanent channels. Therefore, when any other UE sends a request for channel creation, then channel hinting program 112 can disconnect the temporary channels from the first UE, since that UE still has the permanent channels, and reallocate them to the requesting UE. Therefore, if channel hinting program 112 determines that a minimum number of channels per UE is defined for the system (“yes” branch, decision block 520), then channel hinting program 112 proceeds to step 524.

If, however, there is no minimum channel value defined, then then channel hinting program 112 allocates permanent channels with the requesting device to ensure that these channels will not be disconnected by a subsequent channel allocation request. Therefore, if channel hinting program 112 determines that a minimum number of channels per UE is not defined for the system (“no” branch, decision block 520), then channel hinting program 112 proceeds to step 522.

Channel hinting program 112 sends a permanent space available message (step 522). In an embodiment, if channel hinting program 112 determines that the minimum number of channels per UE is not defined for the system (“no” branch, decision block 520), then channel hinting program 112 sends a BCCH message with permanent space available. Channel hinting program 112 then proceeds to decision block 546.

Channel hinting program 112 sends a temporary space available message (step 524). In an embodiment, if channel hinting program 112 determines that the minimum number of channels per UE is defined for the system (“yes” branch, decision block 520), then channel hinting program 112 sends a BCCH message with temporary space available. Channel hinting program 112 then proceeds to decision block 546.

Channel hinting program 112 selects a Peer eNodeB (step 526). In an embodiment, if channel hinting program 112 determines that the notification request is to deallocate Peer eNodeB channels (“yes” branch, decision block 512), then channel hinting program 112 selects a Peer eNodeB from which it has received a notification request with deallocated bearer channels.

Channel hinting program 112 determines if the Peer eNodeB max channels is greater than the actual channels (decision block 528). In an embodiment, channel hinting program 112 determines if the maximum number of channels supported by the Peer eNodeB selected in step 526 is greater than the number of channels currently allocated to the Peer eNodeB. If channel hinting program 112 determines that the maximum number of channels supported by the Peer eNodeB selected in step 526 is not greater than the number of channels currently allocated to the Peer eNodeB (“no” branch, decision block 528), then channel hinting program 112 proceeds to decision block 546. If channel hinting program 112 determines that the maximum number of channels supported by the Peer eNodeB selected in step 526 is greater than the number of channels currently allocated to the Peer eNodeB (“yes” branch, decision block 528), then channel hinting program 112 proceeds to decision block 530.

Channel hinting program 112 determines if the minimum channel value is defined (decision block 530). In an embodiment, channel hinting program 112 determines if a minimum number of channels per peer eNodeB is defined for the system. If a peer eNodeB is configured such that it can create permanent channels with eNodeB, and space is available for more channels between the peer eNodeB and the eNodeB, then channel hinting program 112 allocates temporary channels with this device. This allows the temporary channels to be disconnected since the peer eNodeB will always have connectivity via the permanent channels. Therefore, when any other peer eNodeB sends a request for channel creation, then channel hinting program 112 can disconnect the temporary channels from the first peer eNodeB, since that peer eNodeB still has the permanent channels, and reallocate them to the requesting peer eNodeB. Therefore, if channel hinting program 112 determines that a minimum number of channels per peer eNodeB is defined for the system (“yes” branch, decision block 530), then channel hinting program 112 proceeds to step 534.

If, however, there is no minimum channel value defined, then then channel hinting program 112 allocates permanent channels with the requesting device to ensure that these channels will not be disconnected by a subsequent channel allocation request. Therefore, if channel hinting program 112 determines that a minimum number of channels per peer eNodeB is not defined for the system (“no” branch, decision block 530), then channel hinting program 112 proceeds to step 532.

Channel hinting program 112 sends a permanent space available message (step 532). In an embodiment, if channel hinting program 112 determines that the minimum number of channels per Peer eNodeB is not defined for the system (“no” branch, decision block 530), then channel hinting program 112 sends a BCCH message with permanent space available. Channel hinting program 112 then proceeds to decision block 546.

Channel hinting program 112 sends a temporary space available message (step 534). In an embodiment, if channel hinting program 112 determines that the minimum number of channels per Peer eNodeB is defined for the system (“yes” branch, decision block 530), then channel hinting program 112 sends a BCCH message with temporary space available. Channel hinting program 112 then proceeds to decision block 546.

Channel hinting program 112 selects a gateway (step 536). In an embodiment, if channel hinting program 112 determines that the notification request is to deallocate gateway channels (“yes” branch, decision block 514), then channel hinting program 112 selects a gateway from which it has received a notification request with deallocated bearer channels.

Channel hinting program 112 determines if the gateway max channels is greater than the actual channels (decision block 538). In an embodiment, channel hinting program 112 determines if the maximum number of channels supported by the gateway selected in step 536 is greater than the number of channels currently allocated to the gateway. If channel hinting program 112 determines that the maximum number of channels supported by the gateway selected in step 536 is not greater than the number of channels currently allocated to the gateway (“no” branch, decision block 538), then channel hinting program 112 proceeds to decision block 546. If channel hinting program 112 determines that the maximum number of channels supported by the gateway selected in step 526 is greater than the number of channels currently allocated to the gateway (“yes” branch, decision block 538), then channel hinting program 112 proceeds to decision block 530.

Channel hinting program 112 determines if the minimum channel value is defined (decision block 530). In an embodiment, channel hinting program 112 determines if a minimum number of channels per gateway is defined for the system. If channel hinting program 112 determines that a minimum number of channels per gateway is not defined for the system (“no” branch, decision block 530), then channel hinting program 112 proceeds to step 532. If channel hinting program 112 determines that a minimum number of channels per gateway is defined for the system (“yes” branch, decision block 530), then channel hinting program 112 proceeds to step 534.

Channel hinting program 112 sends a permanent space available message (step 532). In an embodiment, if channel hinting program 112 determines that the minimum number of channels per gateway is not defined for the system (“no” branch, decision block 530), then channel hinting program 112 sends a BCCH message with permanent space available. Channel hinting program 112 then proceeds to decision block 546.

Channel hinting program 112 sends a temporary space available message (step 534). In an embodiment, if channel hinting program 112 determines that the minimum number of channels per gateway is defined for the system (“yes” branch, decision block 530), then channel hinting program 112 sends a BCCH message with temporary space available. Channel hinting program 112 then proceeds to decision block 546.

Channel hinting program 112 determines if additional channels are still available (decision block 546). In an embodiment, channel hinting program 112 determines if additional channels are still available to be reallocated. If channel hinting program 112 determines that no additional channels are available to be reallocated (“no” branch, decision block 546), then channel hinting program 112 ends for this cycle. If channel hinting program 112 determines that additional channels are still available to be reallocated (“yes” branch, decision block 546), then channel hinting program 112 proceeds to step 548.

Channel hinting program broadcasts a channel available message over BCCH (step 548). In an embodiment, channel hinting program 112 broadcasts an appropriate message, based on the type of channels that are available, over the control channel to announce that additional channels are available to be allocated.

Channel hinting program 112 receive message requesting additional logical channels (step 550). In an embodiment, channel hinting program 112 receives a message from a device, e.g., a UE device, requesting that one or more of the recently deallocated channels be assigned to the device.

Channel hinting program 112 sends a connect message to device requesting channels (step 552). In an embodiment, channel hinting program 112 sends a connect message to that device via a control instruction transfer of the Media Access Controller (MAC) protocol over the radio interface.

Channel hinting program 112 receives a response (step 554). In an embodiment, channel hinting program 112 receives a response from the device that requested additional channels in step 550.

Channel hinting program 112 determines if the connection was successful (decision block 556). In an embodiment, channel hinting program 112 determines if the response from the device that requested additional channels in step 550 indicates that the connection was successful.

Channel hinting program 112 adds the channels to the permanent list (step 558). In an embodiment, if channel hinting program 112 determines that the connection was successful, then channel hinting program 112 adds the identification of the channels added to the device to the list of permanent channels.

Channel hinting program 112 adds the channels to the temporary list (step 560). In an embodiment, if channel hinting program 112 determines that the connection was not successful, then channel hinting program 112 adds the identification of the channels added to the device to the list of temporary channels.

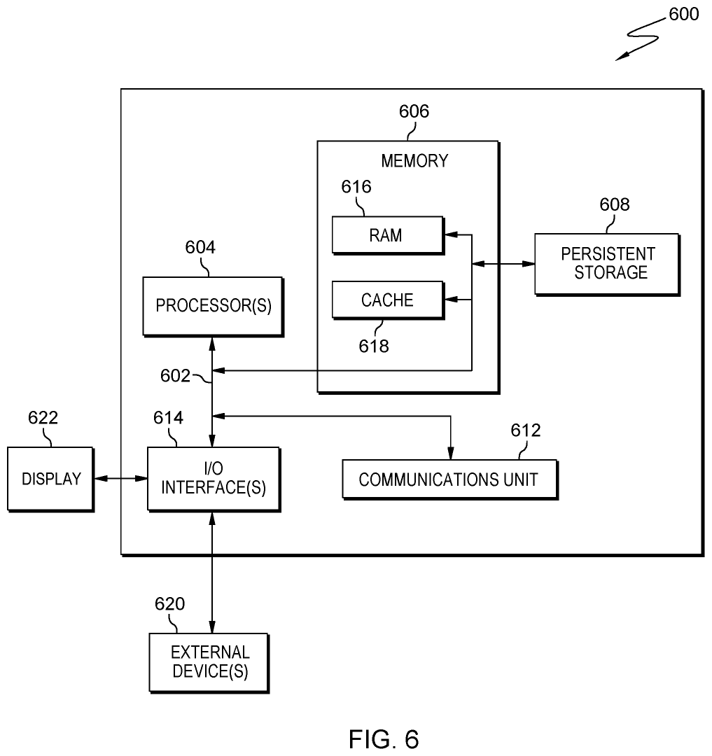

FIG. 6 is a block diagram depicting components of computing device 110 suitable for channel hinting program 112, in accordance with at least one embodiment of the invention. FIG. 6 displays the computer 600, one or more processor(s) 604 (including one or more computer processors), a communications fabric 602, a memory 606 including, a random-access memory (RAM) 616, and a cache 618, a persistent storage 608, a communications unit 612, I/O interfaces 614, a display 622, and external devices 620. It should be appreciated that FIG. 6 provides only an illustration of one embodiment and does not imply any limitations with regard to the environments in which different embodiments may be implemented. Many modifications to the depicted environment may be made.

As depicted, the computer 600 operates over the communications fabric 602, which provides communications between the computer processor(s) 604, memory 606, persistent storage 608, communications unit 612, and input/output (I/O) interface(s) 614. The communications fabric 602 may be implemented with an architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a RAM 616 and a cache 618. In general, the memory 606 can include any suitable volatile or non-volatile computer readable storage media. Cache 618 is a fast memory that enhances the performance of processor(s) 604 by holding recently accessed data, and near recently accessed data, from RAM 616.

Program instructions for channel hinting program 112 may be stored in the persistent storage 608, or more generally, any computer readable storage media, for execution by one or more of the respective computer processors 604 via one or more memories of the memory 606. The persistent storage 608 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

The communications unit 612, in these examples, provides for communications with other data processing systems or devices. In these examples, the communications unit 612 includes one or more network interface cards. The communications unit 612 may provide communications through the use of either or both physical and wireless communications links. In the context of some embodiments of the present invention, the source of the various input data may be physically remote to the computer 600 such that the input data may be received, and the output similarly transmitted via the communications unit 612.

The I/O interface(s) 614 allows for input and output of data with other devices that may be connected to computer 600. For example, the I/O interface(s) 614 may provide a connection to external device(s) 620 such as a keyboard, a keypad, a touch screen, a microphone, a digital camera, and/or some other suitable input device. External device(s) 620 can also include portable computer readable storage media such as, for example, thumb drives, portable optical or magnetic disks, and memory cards. Software and data used to practice embodiments of the present invention, e.g., channel hinting program 112, can be stored on such portable computer readable storage media and can be loaded onto persistent storage 608 via the I/O interface(s) 614. I/O interface(s) 614 also connect to a display 622.

Display 622 provides a mechanism to display data to a user and may be, for example, a computer monitor. Display 622 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for bearer channel accommodation hinting, the computer-implemented method comprising:
responsive to receiving a message to deallocate one or more bearer channels, retrieving, by one or more computer processors, a count of deletion requests, wherein the count of deletion requests includes the one or more deallocated bearer channels;
responsive to determining the type of bearer channel of the one or more bearer channels deleted, selecting, by the one or more computer processors, an appropriate device of one or more connected devices, wherein the appropriate device is chosen from the group consisting of a user equipment, a peer base station, and a gateway; and
sending, by the one or more computer processors, a hinting message to the appropriate device that the one or more deallocated bearer channels are available.

2. The computer-implemented method of claim 1, wherein responsive to receiving the message to deallocate the one or more bearer channels, retrieving the count of deletion requests comprises:
receiving, by the one or more computer processors, the message to deallocate the one or more bearer channels;
determining, by the one or more computer processors, a channel identification of the one or more bearer channels;
determining, by the one or more computer processors, a resource set of the one or more bearer channels;
adding, by the one or more computer processors, the resource set of the one or more bearer channels to a deallocated resource list; and
sending, by the one or more computer processors, the deallocated resource list to a notification manager.

3. The computer-implemented method of claim 1, wherein sending a hinting message to the appropriate device that the one or more deallocated bearer channels are available comprises:
determining, by the one or more computer processors, whether a maximum number of channels supported by the appropriate device is greater than a number of channels currently allocated to the appropriate device;
responsive to determining that the maximum number of channels supported by the appropriate device is greater than the number of channels currently allocated to the appropriate device, determining, by the one or more computer processors, whether a minimum channel value is defined for the appropriate device;
responsive to determining that the minimum channel value is defined for the appropriate device, sending, by the one or more computer processors, a temporary space available message to the appropriate device; and
responsive to determining that the appropriate device has successfully completed the connection of the one or more deallocated bearer channels, adding, by the one or more computer processors, the one or more deallocated bearer channels to a list of temporary channels.

4. The computer-implemented method of claim 3, further comprising:
responsive to determining that the minimum channel value is not defined for the appropriate device, sending, by the one or more computer processors, a permanent space available message to the appropriate device; and
responsive to determining that the appropriate device has successfully completed the connection of the one or more deallocated bearer channels, adding, by the one or more computer processors, the one or more deallocated bearer channels to a list of permanent channels.

5. The computer-implemented method of claim 3, further comprising, responsive to receiving a request to allocate one or more bearer channels to a new device, deallocating, by the one or more computer processors, one or more temporary bearer channels from one or more temporary connected devices, wherein the one or more temporary bearer channels are selected from a list of permanent channels.

6. The computer-implemented method of claim 1, wherein the appropriate device determines whether to connect to the one or more deallocated bearer channels based on a packet data workload pattern of the appropriate device.

7. The computer-implemented method of claim 1, further comprising, responsive to determining that all bearer channels of the one or more bearer channels are allocated to one or more appropriate devices, monitoring, by the one or more computer processors, one or more memory regions of the base station to determine if any bearer channels of the one or more bearer channels become deallocated.

8. The computer-implemented method of claim 1, wherein sending the hinting message to the appropriate device that the one or more deallocated bearer channels are available further comprises:
determining, by the one or more computer processors, whether one or more active devices has one or more available bearer channels; and
responsive to determining that the one or more active devices has the one or more available bearer channels, sending, by the one or more computer processors, the hinting message to the one or more active devices.

9. A computer program product for bearer channel accommodation hinting, the computer program product comprising one or more computer readable storage media and program instructions stored on the one or more computer readable storage media, the program instructions including instructions to:
responsive to receiving a message to deallocate one or more bearer channels, retrieve a count of deletion requests, wherein the count of deletion requests includes the one or more deallocated bearer channels;
responsive to determining a type of bearer channel of the one or more bearer channels deleted, select an appropriate device of one or more connected devices, wherein the appropriate device is chosen from the group consisting of a user equipment, a peer base station, and a gateway; and
send a hinting message to the appropriate device that the one or more deallocated bearer channels are available.

10. The computer program product of claim 9, wherein responsive to receiving the message to deallocate the one or more bearer channels, retrieving the count of deletion requests comprises one or more of the following program instructions, stored on the one or more computer readable storage media, to:
receive the message to deallocate the one or more bearer channels;
determine a channel identification of the one or more bearer channels;
determine a resource set of the one or more bearer channels;
add the resource set of the one or more bearer channels to a deallocated resource list; and
the deallocated resource list to a notification manager.

11. The computer program product of claim 9, wherein sending a hinting message to the appropriate device that the one or more deallocated bearer channels are available comprises one or more of the following program instructions, stored on the one or more computer readable storage media, to:
determine whether a maximum number of channels supported by the appropriate device is greater than a number of channels currently allocated to the appropriate device;
responsive to determining that the maximum number of channels supported by the appropriate device is greater than the number of channels currently allocated to the appropriate device, determine whether a minimum channel value is defined for the appropriate device;
responsive to determining that the minimum channel value is defined for the appropriate device, send a temporary space available message to the appropriate device; and
responsive to determining that the appropriate device has successfully completed the connection of the one or more deallocated bearer channels, add the one or more deallocated bearer channels to a list of temporary channels.

12. The computer program product of claim 11, further comprising one or more of the following program instructions, stored on the one or more computer readable storage media, to:
responsive to determining that the minimum channel value is not defined for the appropriate device, send a permanent space available message to the appropriate device; and
responsive to determining that the appropriate device has successfully completed the connection of the one or more deallocated bearer channels, add the one or more deallocated bearer channels to a list of permanent channels.

13. The computer program product of claim 11, further comprising, responsive to receiving a request to allocate one or more bearer channels to a new device, deallocate one or more temporary bearer channels from one or more temporary connected devices, wherein the one or more temporary bearer channels are selected from a list of permanent channels.

14. The computer program product of claim 9, wherein the appropriate device determines whether to connect to the one or more deallocated bearer channels based on a packet data workload pattern of the appropriate device.

15. The computer program product of claim 9, further comprising, responsive to determining that all bearer channels of the one or more bearer channels are allocated to one or more appropriate devices, monitor one or more memory regions of the base station to determine if any bearer channels of the one or more bearer channels become deallocated.

16. The computer program product of claim 9, wherein sending the hinting message to the appropriate device that the one or more deallocated bearer channels are available further comprises one or more of the following program instructions, stored on the one or more computer readable storage media, to:
determine whether one or more active devices has one or more available bearer channels; and
responsive to determining that the one or more active devices has the one or more available bearer channels, send the hinting message to the one or more active devices.

17. A computer system for bearer channel accommodation hinting, the computer system comprising:
one or more computer processors;
one or more computer readable storage media; and
program instructions stored on the one or more computer readable storage media for execution by at least one of the one or more computer processors, the stored program instructions including instructions to:
responsive to receiving a message to deallocate one or more bearer channels, retrieve a count of deletion requests, wherein the count of deletion requests includes the one or more deallocated bearer channels;
responsive to determining a type of bearer channel of the one or more bearer channels deleted, select an appropriate device of one or more connected devices, wherein the appropriate device is chosen from the group consisting of a user equipment, a peer base station, and a gateway; and
send a hinting message to the appropriate device that the one or more deallocated bearer channels are available.

18. The computer system of claim 17, wherein responsive to receiving the message to deallocate the one or more bearer channels, retrieving the count of deletion requests comprises one or more of the following program instructions, stored on the one or more computer readable storage media, to:
receive the message to deallocate the one or more bearer channels;
determine a channel identification of the one or more bearer channels;
determine a resource set of the one or more bearer channels;
add the resource set of the one or more bearer channels to a deallocated resource list; and
the deallocated resource list to a notification manager.

19. The computer system of claim 17, wherein sending a hinting message to the appropriate device that the one or more deallocated bearer channels are available comprises one or more of the following program instructions, stored on the one or more computer readable storage media, to:
determine whether a maximum number of channels supported by the appropriate device is greater than a number of channels currently allocated to the appropriate device;
responsive to determining that the maximum number of channels supported by the appropriate device is greater than the number of channels currently allocated to the appropriate device, determine whether a minimum channel value is defined for the appropriate device;
responsive to determining that the minimum channel value is defined for the appropriate device, send a temporary space available message to the appropriate device; and
responsive to determining that the appropriate device has successfully completed the connection of the one or more deallocated bearer channels, add the one or more deallocated bearer channels to a list of temporary channels.

20. The computer system of claim 19, further comprising one or more of the following program instructions, stored on the one or more computer readable storage media, to:
responsive to determining that the minimum channel value is not defined for the appropriate device, send a permanent space available message to the appropriate device; and
responsive to determining that the appropriate device has successfully completed the connection of the one or more deallocated bearer channels, add the one or more deallocated bearer channels to a list of permanent channels.
